(19) United States
(12) Patent Application Publication
(10) Pub. No.: US 2024/0277572 A1
(43) Pub. Date: Aug. 22, 2024

(54) MEDICINE CONTAINER, METHOD OF ASSEMBLING THE CONTAINER, AND METHOD OF MANUFACTURING THE CONTAINER

(71) Applicant: AbbVie Inc., North Chicago, IL (US)

(72) Inventors: Bhimaprasad Medhal, Lake Forest, IL (US); James J. Hughes, Libertyville, IL (US)

(21) Appl. No.: 18/601,787

(22) Filed: Mar. 11, 2024

Related U.S. Application Data
(63) Continuation of application No. 16/972,129, filed on Dec. 4, 2020, now abandoned.
(60) Provisional application No. 62/689,911, filed on Jun. 26, 2018.

(51) Int. Cl. A61J 1/03; B65D 51/30; B65D 81/26

(52) U.S. Cl. CPC A61J 1/03; B65D 51/30; B65D 81/266

(57) ABSTRACT

A medicine container that includes a container body comprising a bottom wall that at least partially defines an interior of the container body, wherein the bottom wall comprises a protrusion extending into the interior, and a canister base coupled to the protrusion, wherein the canister base is configured to hold a desiccant canister within the interior of the container body when the canister base is coupled to the protrusion.

### CROSS-REFERENCE TO RELATED APPLICATIONS

This application is a continuation of U.S. patent application Ser. No. 16/972,129, filed Dec. 4, 2020, which is a 35 U.S.C. § 371 National Phase Application that claims priority to PCT Application Serial No. PCT/US19/38902, filed Jun. 25, 2019, which claims priority to U.S. Provisional Application No. 62/689,911, filed Jun. 26, 2018, each of which are hereby incorporated by reference in their entirety.

### BACKGROUND

The field of the present disclosure relates generally to medicine containers and, more specifically, to a moisture and oxygen resistant medicine container for storing a plurality of doses of medication, and for holding a desiccant canister therein to control moisture and oxygen absorption by the doses of medication.

At least some known pharmaceutical products need to be protected from exposure to moisture and oxygen, for example, to maintain the efficacy of the products. To this end, the pharmaceutical products may be packaged and stored in a sealed container along with a desiccant. The desiccant facilitates extending the shelf life of the products by scavenging moisture and oxygen from the interior of the container, and the desiccant may be integrated within the container in any number of ways.

For example, in at least some known medicine containers, one or more desiccant particles or containers are inserted into the container and allowed to freely move therein along with the stored pharmaceutical products. However, allowing the desiccant to freely move in the container enables the desiccant to be inadvertently dispensed from the container, which may result in disposal of the desiccant by a consumer. Allowing the desiccant to freely move in the container also facilitates increasing the difficulty of dispensing pharmaceutical products from the container by potentially obstructing a container opening with the desiccant.

Alternatively, the desiccant may be integrated with a cap of the container, or with a seal that covers the container opening. More specifically, when integrated with the cap, the desiccant is oriented to extend through the container opening and into the interior of the container when the cap is used to enclose the interior. However, extending the desiccant through the container opening precludes induction sealing of the container opening. Moreover, implementing the desiccant-integrated seal generally requires significant modifications to be made to the container opening and to a container assembly line.

Some known medicine containers are adapted to receive and hold a desiccant-containing insert therein. For example, holding members may be formed on the side wall of the containers, and the insert may be retained within the container by the holding members. However, the design of the container is constrained by the shape and size of the insert in that the container opening must be sized to facilitate installation of the insert within the container through the opening. In addition, the desiccant insert must extend to the side wall of the container to be retained by the holding members. As such, the volume and storage capacity of the interior is reduced, and an exposure area between the desiccant and the pharmaceutical products is also reduced.

Accordingly, a desiccant-containing medicine container is needed that holds desiccants in a fixed position therein to prevent neck blockage, and that includes means for holding the desiccants within the container that do not significantly impact the standard outer shape, storage volume, and/or other functionality of the container.

### BRIEF DESCRIPTION

In one aspect, a medicine container is provided. The medicine container includes a container body comprising a bottom wall that at least partially defines an interior of the container body, wherein the bottom wall comprises a protrusion extending into the interior, and a canister base coupled to the protrusion, wherein the canister base is configured to hold a desiccant canister within the interior of the container body when the canister base is coupled to the protrusion.

In another aspect, a medicine container is provided. The medicine container includes a container body comprising a bottom wall that at least partially defines an interior of the container body, wherein the bottom wall comprises a protrusion extending into the interior, and a canister base formed separately from, and then integrally joined with, the protrusion, wherein the canister base is configured to hold a desiccant canister within the interior of the container body when the canister base is coupled to the protrusion.

In yet another aspect, a method of assembling a medicine container is provided. The method includes inserting a canister base through an opening in the medicine container, wherein the medicine container includes a container body having a bottom wall and an interior at least partially defined by the bottom wall, wherein the bottom wall includes a protrusion extending into the interior, coupling the canister base to the protrusion, and coupling a desiccant canister to the canister base.

### BRIEF DESCRIPTION OF THE DRAWINGS

FIG. 1 is a cutaway perspective view of an example medicine container.

FIG. 2 is an enlarged cutaway perspective view of a portion of the medicine container shown in FIG. 1.

FIG. 3 is a cutaway perspective view of a bottom portion of the medicine container shown in FIG. 1.

FIG. 4 is a perspective view of an example canister base.

FIG. 5 is a cross-sectional view of the canister base shown in FIG. 4.

FIG. 6 is a perspective view of an example desiccant canister.

FIG. 7 is a cross-sectional view of the desiccant canister shown in FIG. 6.

FIG. 8 is a perspective view of an example canister assembly shown in FIG. 1.

FIG. 9 is a perspective view of an additional canister assembly that may be used in the medicine container shown in FIG. 1.

FIG. 10 is a flow diagram illustrating a series of process steps for manufacturing a medicine container.

FIG. 11 is a cutaway perspective view of an additional medicine container.

FIG. 12 is a cutaway perspective view of a bottom portion of the medicine container shown in FIG. 11.

FIG. 13 is a perspective view of the canister base shown in FIG. 11.

FIG. 14 is a perspective view of an additional canister base that may be used with the medicine container shown in FIG. 11.

FIG. 15 is a perspective view of an additional canister base that may be used with the medicine container shown in FIG. 11.

FIG. 16 is an exploded view of an example assembly apparatus that may be used to assemble the medicine container shown in FIG. 11.

FIG. 17 is a perspective view of an additional canister base that may be used with the medicine container shown in FIG. 11.

FIG. 18 is a cross-sectional view of the canister base shown in FIG. 17.

FIG. 19 is a top view of the canister base shown in FIG. 17.

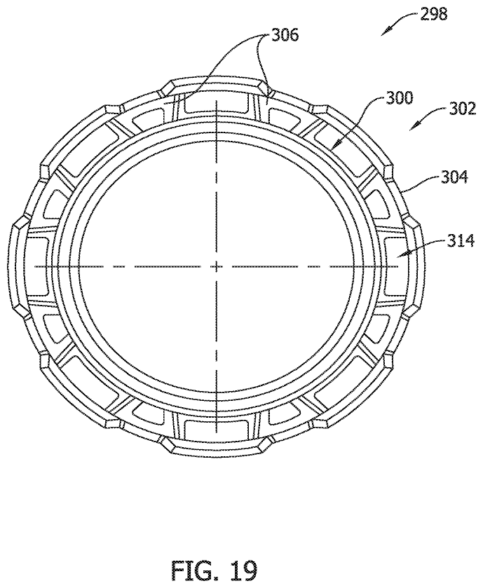

FIG. 20 is a front partial cutaway view of an additional medicine container.

FIG. 21 is a cross-sectional view of the medicine container shown in FIG. 20.

FIG. 22 is a perspective cross-sectional view of an additional canister base that may be used in the medicine container shown in FIG. 20.

FIG. 23 is a partial cutaway view of an additional medicine container.

FIG. 24 is a cross-sectional view of the medicine container shown in FIG. 23.

FIG. 25 is a perspective view of an additional elongated canister base that may be used in the medicine container shown in FIG. 23.

FIG. 26 is a cross-sectional view of the elongated canister base shown in FIG. 25.

FIG. 27 is a partial cutaway view of an additional medicine container.

FIG. 28 is a cross-sectional view of the medicine container shown in FIG. 27.

### DETAILED DESCRIPTION

The following detailed description illustrates the disclosure by way of example and not by way of limitation. The description enables one skilled in the art to make and use the disclosure, describes several embodiments, adaptations, variations, alternatives, and use of the disclosure, including what is presently believed to be the best mode of carrying out the disclosure.

Embodiments of the present disclosure relate to a moisture and oxygen resistant medicine container for storing a plurality of doses of medication, and for holding a desiccant canister therein to control moisture and oxygen absorption by the doses of medication. The medicine container includes a container body, including a bottom wall having a protrusion formed thereon, and a canister base removably coupleable to the protrusion. The canister base is also configured to hold a desiccant canister such that the desiccant canister is in a fixed and stationary position within the interior of the container when the canister base is coupled to the protrusion. In one embodiment, the desiccant canister is a cylindrical housing that contains desiccant particles therein. The cylindrical housing has air flow openings defined therein such that moisture and oxygen entrained in air that flows through the housing can be scavenged by the desiccant. The desiccant canister may be mass-produced and commercially available from a party, such as a manufacturer. As such, in some embodiments, the canister base is designed for compatibility with the commercially available desiccant canister.

As noted above, the medicine container described herein facilitates holding a desiccant canister in a fixed and stationary position within the interior of the container. More specifically, the desiccant canister is held at the bottom of the container by the canister base. As such, the canister base and the desiccant canister do not impede induction sealing of the container during an assembly process. Moreover, the desiccant canister is prevented from blocking dispensation of medication from a container opening and/or from being discharged from the container and then disposed of by a consumer, for example. As used herein, the term “user” or “consumer” means a person or person(s) who is consuming or using contents from the container assembly (e.g., a patient), a healthcare provider, and/or a patient assistant providing the contents from the container to the person(s) consuming the contents from the container.

The medicine container also does not significantly impact the standard outer shape, storage volume, and/or other functionality of the container. More specifically, configuring the canister base for attachment to the bottom wall provides advantages over other known container designs. For example, the canister base does not need to extend to the side walls of the container to be attached therein, thereby reducing the canister base's physical footprint, and facilitating increased exposure of container contents to the desiccant by allowing the contents to fill the space between the side walls and the desiccant canister. In addition, assembly of the container includes inserting the canister base through a neck opening in the container and then attaching the canister base to the bottom wall. As such, the size of the canister base is selected to facilitate insertion through the neck opening, but configuring the canister base for attachment to the bottom wall enables the size of the remainder of the container to be selected independent of the size of the canister base. Thus, the medicine container described herein may be formed with a standard outer shape, defined by a small neck portion and a comparatively larger container portion, which facilitates reducing spillage of the container contents when the container is tipped on its side.

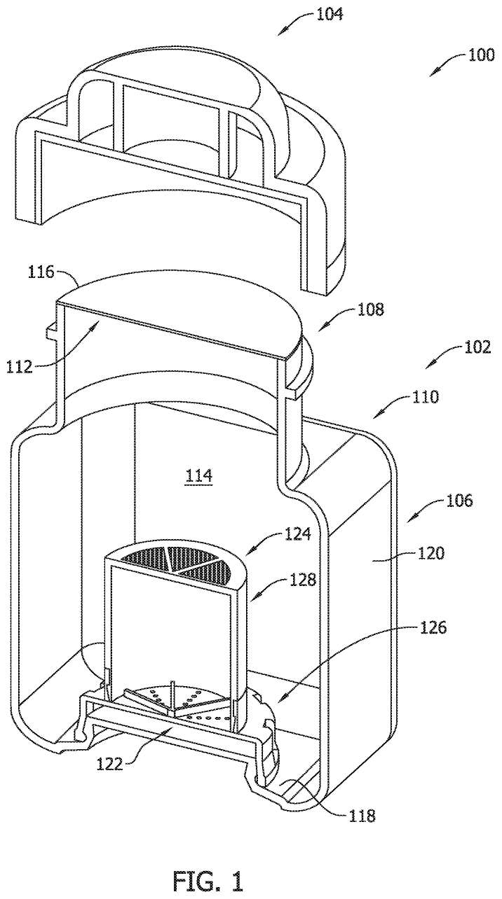

Referring now to the drawings, FIG. 1 is a cutaway perspective view of an example medicine container 100. In the example embodiment, medicine container 100 includes a container body 102 and a container cap 104 that is removably coupleable to container body 102. More specifically, container body 102 includes a container portion 106 and a neck portion 108, and container cap 104 is configured to engage neck portion 108 to close medicine container 100. In one embodiment, container portion 106 has a greater width than neck portion 108 such that container body 102 further includes a shoulder portion 110 defined therebetween.

Neck portion 108 defines an opening 112 that provides access to an interior 114 of container body 102, and container cap 104 covers opening 112 when coupled to container body 102. In one embodiment, opening 112 is initially sealed by an induction seal 116 coupled to neck portion 108. Induction seal 116 facilitates protecting the contents of medicine container 100 from exposure to moisture and/or oxygen, for example, to facilitate increasing the shelf life of the contents during shipping and/or storage of medicine container 100. In some embodiments, container cap 104 includes a seal cutter (not shown) that enables a consumer to break induction seal 116.

Referring to FIGS. 1-3, container body 102 includes a bottom wall 118 and a side wall 120. In the example embodiment, bottom wall 118 has a protrusion 122 formed thereon, and protrusion 122 is oriented to extend into interior 114. In addition, medicine container 100 includes a canister assembly 124 positioned within interior 114. Canister assembly 124 includes a canister base 126 and a desiccant canister 128 coupled to canister base 126, as will be explained in more detail below. Canister base 126 is removably coupled to protrusion 122. When coupled to protrusion 122, desiccant canister 128 is held in a fixed and stationary position within interior 114 of container body 102.

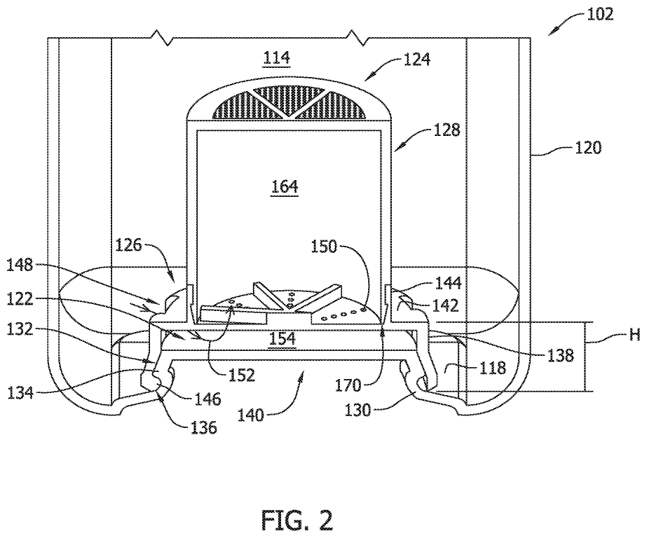

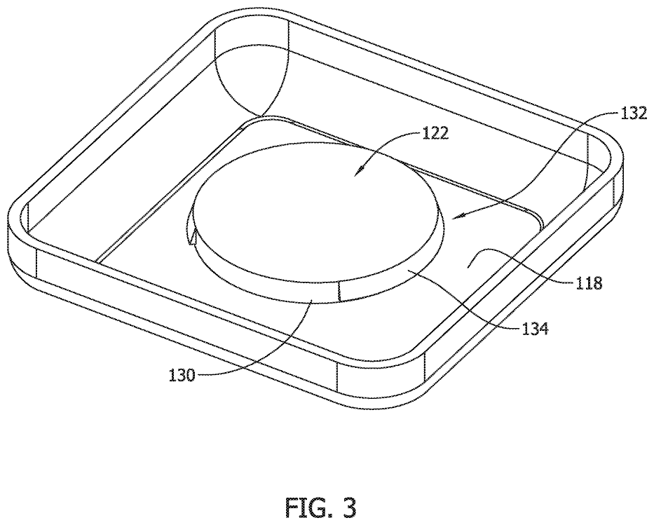

In the example embodiment, canister base 126 is coupled to protrusion 122 with a snap-fit connection. For example, as shown in FIGS. 2 and 3, protrusion 122 includes a side wall 130 having at least one engagement feature 132 formed thereon. Engagement feature 132 includes a radial projection 134 that extends from side wall 130 such that a recess 136 is defined between radial projection 134 and bottom wall 118. Recess 136 is sized to receive a portion of canister base 126 therein to facilitate holding canister base 126 to protrusion 122 with the snap-fit connection, as will be explained in more detail below.

In one embodiment, engagement feature 132 includes a pair of radial projections 134 formed on diametrically opposing sides of protrusion 122. Alternatively, radial projection 134 is formed along the entire circumference of protrusion 122.

Canister base 126 includes a side wall 138 that defines an opening 140 in canister base 126, a top wall 142 opposite opening 140, and a canister socket 144 formed on top wall 142. Canister base 126 is sized to extend over protrusion 122 such that protrusion 122 is insertable within opening 140 when canister base 126 is coupled to protrusion 122. In addition, side wall 138 includes at least one engagement member 146 formed thereon. In one embodiment, a plurality of engagement members 146 are arranged circumferentially about opening 140.

In the example embodiment, the size of opening 140 between diametrically opposing engagement members 146 is less than the diameter of protrusion 122 including diametrically opposing radial projections 134 extending therefrom. Moreover, canister base 126 is fabricated from any material that enables medicine container 100 to function as described herein. For example, canister base 126 may be fabricated from a plastic material that is flexible and/or elastically deformable when a predetermined force is applied thereto. Canister base 126 is sized smaller than opening 112 in neck portion 108 such that canister base 126 is insertable through opening 112. As such, during assembly of medicine container 100, canister base 126 and/or desiccant canister 128 can be inserted through opening 112 in neck portion 108 for coupling to protrusion 122. For example, either canister base 126 is inserted through opening 112 for coupling to protrusion 122 and then desiccant canister 128 is coupled to canister base 126 within interior 114, or canister assembly 124, including desiccant canister 128 coupled to canister base 126, is inserted through opening 112 for coupling to protrusion 122. In both assembly operations, canister base 126 is maneuvered over protrusion 122 to engage the snap-fit connection. That is, side wall 138 of canister base 126 flexes radially outward to enable insertion of protrusion 122 through opening 140, and to facilitate positioning engagement members 146 between engagement feature 132 and bottom wall 118. As such, engagement members 146 grip engagement feature 132 to facilitate holding canister base 126 against bottom wall 118.

In an alternative embodiment, protrusion 122 may be fabricated from a plastic material that is flexible and/or elastically deformable, and canister base 126 is fabricated from a plastic material that is substantially rigid and comparatively inflexible relative to the protrusion material. As such, during assembly of medicine container 100, radial projections 134 of protrusion 122 flex radially inward to enable insertion of protrusion 122 through opening 140.

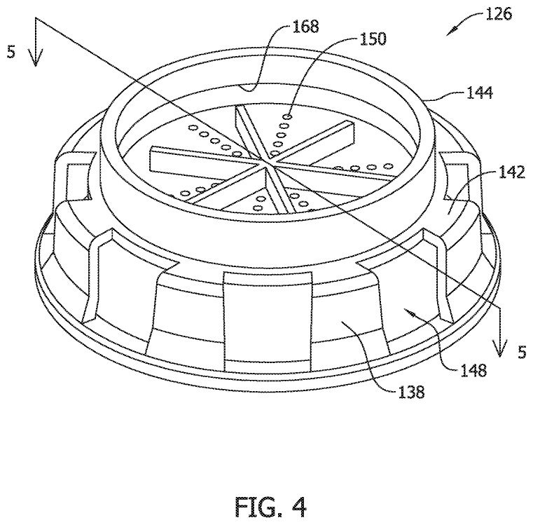

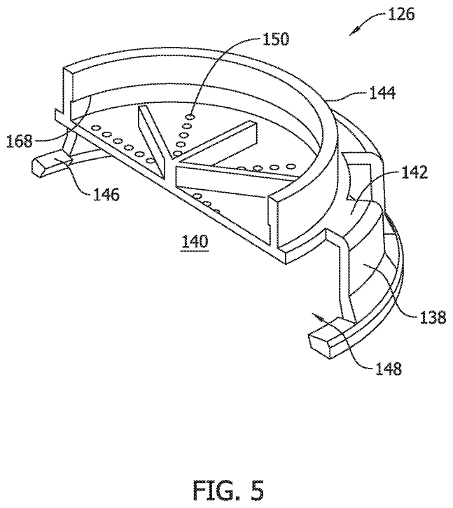

FIG. 4 is a perspective view of canister base 126, and FIG. 5 is a cross-sectional view of canister base 126, as taken along Line 5-5 (shown in FIG. 4). In the example embodiment, side wall 138 and top wall 142 of canister base 126 each include at least one air flow opening defined therein. More specifically, side wall 138 includes at least one air flow cutout 148 formed therein, and top wall 142 includes at least one air flow opening 150 defined therein. As such, referring to FIG. 2, air flow cutout 148 and air flow opening 150 provide an air flow path 152 between interior 114 of container body 102 and desiccant canister 128 through canister base 126. As such, desiccants contained within desiccant canister 128 are in flow communication with the air in interior 114, which enables the desiccants to scavenge moisture and oxygen from the air. In addition, because canister base 126 is spaced from side wall 120 of container body 102, air flow cutouts 148 facilitate enhancing the scavenging capability of the desiccants by providing air flow communication between the desiccants and interior 114 on all sides of canister base 126.

Creation of air flow path 152 is further facilitated by the interaction between protrusion 122 and canister base 126. In the example embodiment, referring again to FIG. 2, side wall 138 of canister base 126 has a height H that is greater than a distance that protrusion 122 extends into interior 114. As such, when canister base 126 is coupled to protrusion 122, a gap 154 is defined between protrusion 122 and top wall 142 of canister base 126. Gap 154 further defines air flow path 152.

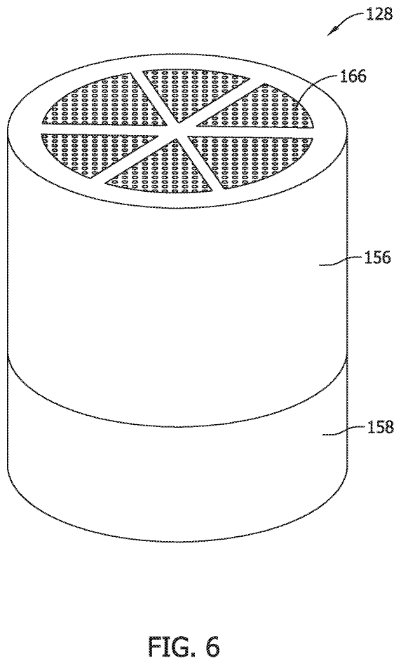

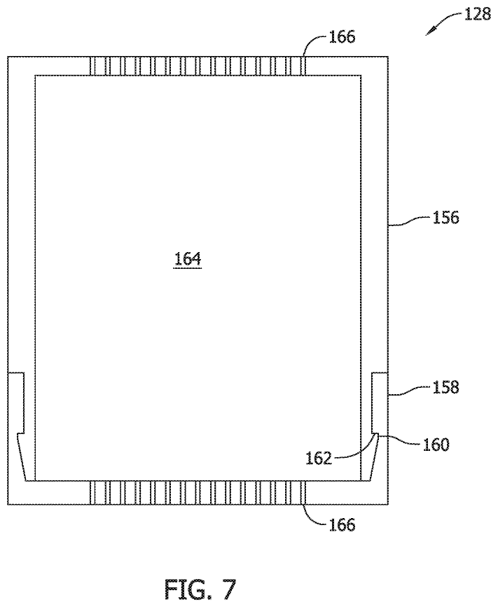

FIG. 6 is a perspective view of an example desiccant canister 128, and FIG. 7 is a cross-sectional view of desiccant canister 128. In the example embodiment, desiccant canister 128 includes a canister portion 156 and a lid portion 158 coupled to canister portion 156. As shown in FIG. 7, canister portion 156 and lid portion 158 are coupled together with a snap-fit connection. For example, canister portion 156 is formed with an undercut feature 160, and lid portion 158 is formed with a retaining feature 162 that engages undercut feature 160.

In the example embodiment, canister portion 156 and lid portion 158 define an interior 164 of desiccant canister 128, and desiccant particles (not shown) are contained within interior 164. Canister portion 156 and lid portion 158 also include a plurality of air flow openings 166 defined therein that provide flow communication between interior 164 and an ambient environment exterior of desiccant canister 128. As such, air flow openings 166 enable the desiccant particles to scavenge moisture and oxygen entrained in the air channeled into interior 164 from the ambient environment through air flow openings 166. In some embodiments, lid portion 158 is removable from canister portion 156 to further expose the desiccant particles to the ambient environment, and to facilitate coupling canister portion 156 to canister base 126 (shown in FIG. 4), as will be explained in more detail below.

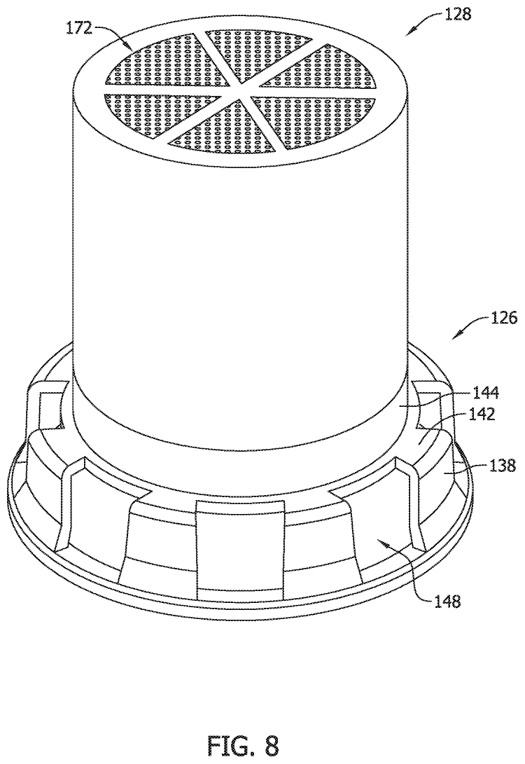

For example, referring to FIGS. 2, 4, 5 and 8, canister socket 144 is configured to hold desiccant canister 128 in a fixed position within interior 114 of container body 102. For example, canister socket 144 includes at least one retaining feature 168 formed thereon, and retaining feature 168 is configured to hold desiccant canister 128 on canister base 126. As noted above, desiccant canister 128 may be a commercially available product, and lid portion 158 (shown in FIG. 7) of desiccant canister 128 is formed with retaining feature 162 (shown in FIG. 7) to enable a snap-fit connection between canister portion 156 and lid portion 158. In one embodiment, retaining feature 168 is substantially identical to retaining feature 162, thereby enabling canister portion 156 of desiccant canister 128 to be coupled to canister socket 144 with a snap-fit connection.

In addition, canister portion 156 of desiccant canister 128 includes an open end 170 when lid portion 158 is removed from canister portion 156 and a closed end 172. In the example embodiment, canister portion 156 is oriented such that open end 170 is closer to bottom wall 118 of container body 102 than closed end 172, and such that open end 170 is abutted against top wall 142 of canister base 126. As such, air flow path 152 provides flow communication between interior 114 of container body 102 and interior 164 of canister portion 156 to facilitate enhancing the scavenging capability of desiccant particles contained within interior 164.

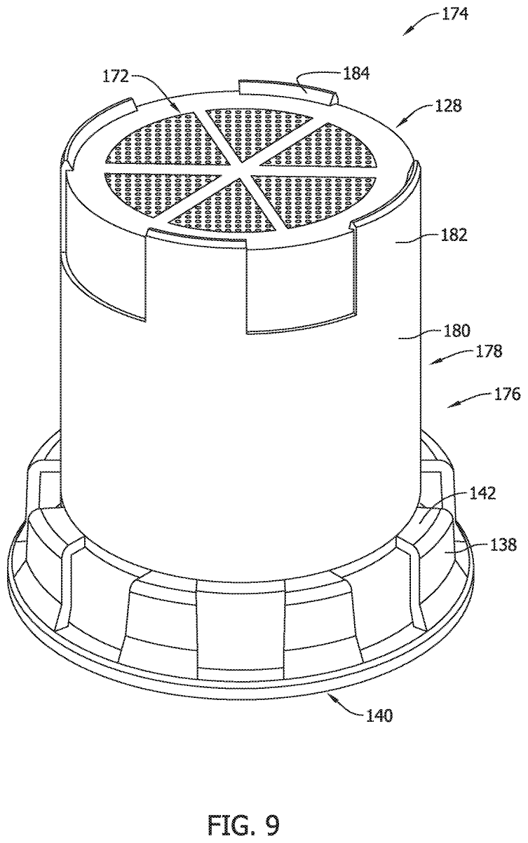

FIG. 9 is a perspective view of an additional canister assembly 174 that may be used in medicine container 100 (shown in FIG. 1). In the example embodiment, canister assembly 174 includes a canister base 176 and desiccant canister 128 coupled to canister base 176. Similar to canister base 126 (shown in FIG. 7), canister base 176 also includes side wall 138 that defines opening 140 in canister base 176, and top wall 142 opposite opening 140. Canister base 176 also includes a canister socket 178 formed on top wall 142. In the example embodiment, canister socket 178 includes a socket body 180 and a plurality of holding arms 182 extending from socket body 180. Socket body 180 is sized to extend over and at least partially encapsulate desiccant canister 128 therein. In addition, canister base 176 is made of material that enables holding arms 182 to flex radially outward relative to socket body 180, thereby enabling insertion of desiccant canister 128 within socket body 180 during assembly of canister assembly 174.

Moreover, holding arms 182 include a retaining feature 184 formed thereon. As noted above, socket body 180 is sized to extend over and at least partially encapsulated desiccant canister 128 therein. Holding arms 182 extend from socket body 180 and beyond closed end 172 of desiccant canister 128. As such, retaining feature 162 engages closed end 172 of desiccant canister 128 to facilitate holding desiccant canister 128 within socket body 180.

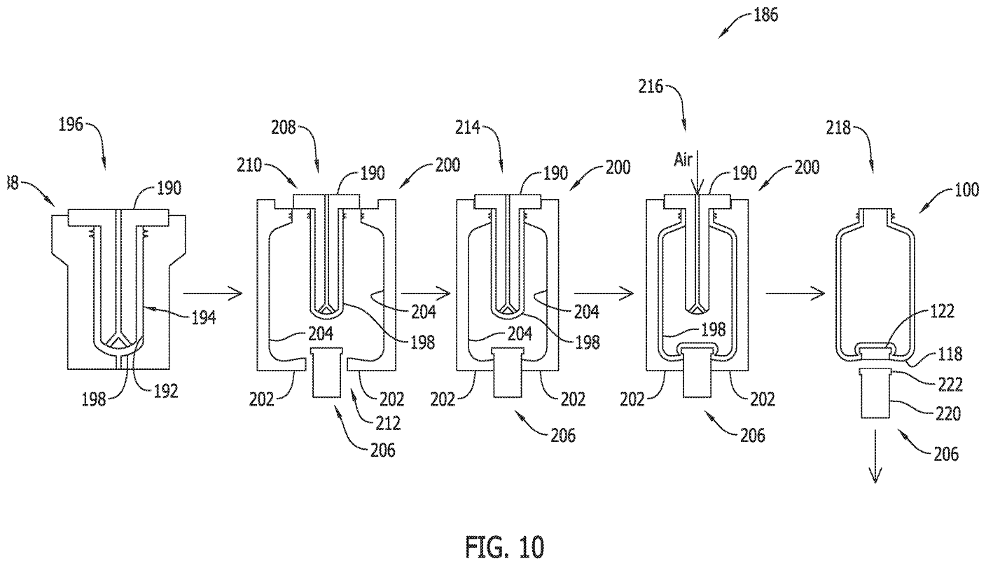

FIG. 10 is a flow diagram illustrating a series of process steps for manufacturing medicine container 100. In the example embodiment, the series of process steps are executed by a blow molding system 186. Blow molding system 186 includes a first mold assembly 188 and a blow molding insert 190 positioned within first mold assembly 188. Blow molding insert 190 is positioned a distance from side walls 192 of first mold assembly 188 such that a cavity 194 is defined therebetween. In a first process step 196, thermoplastic material is injected into cavity 194 such that a molding preform 198 is formed about blow molding insert 190. Blow molding insert 190 is then removed from first mold assembly 188.

Blow molding system 186 also includes a second mold assembly 200 including a pair of mold halves 202 that are translatable relative to each other to facilitate forming medicine container 100. Mold halves 202 each include an interior side wall 204 that, when combined, facilitate forming the outer profile of medicine container 100. Blow molding system 186 also includes a forming member 206 configured to form protrusion 122 in medicine container 100, as will be explained in more detail below. In a second process step 208, mold halves 202 are separated from each other, and blow molding insert 190 and forming member 206 are positioned between mold halves 202. For example, blow molding insert 190 is positioned at a top end 210 of second mold assembly 200, and forming member 206 is positioned at an opposing bottom end 212 of second mold assembly 200. Bottom end 212 is shaped to define bottom wall 118 of medicine container 100.

In a third process step 214, mold halves 202 are translated towards each other such that blow molding insert 190 and forming member 206 are enclosed between mold halves 202. In a fourth process step 216, air is injected into blow molding insert 190 to expand molding preform 198 to conform to the contours of second mold assembly 200 and forming member 206. More specifically, molding preform 198 is in a semi-solid state, and injecting air into blow molding insert 190 facilitates expanding molding preform 198 away from blow molding insert 190 and towards mold halves 202.

In a fifth process step 218, molding preform 198 is allowed to at least partially harden, mold halves 202 are translated away from molding preform 198, and blow molding insert 190 and forming member 206 are removed from second mold assembly 200 and/or medicine container 100. As noted above, forming member 206 is configured to form protrusion 122 in medicine container 100. In the example embodiment, forming member 206 includes a body portion 220 and a radial flange 222 configured to define engagement feature 132 on protrusion 122. In fifth process step 218, molding preform 198 is allowed to at least partially harden around radial flange 222 before removing forming member 206 from second mold assembly 200 and/or medicine container 100.

Because radial flange 222 has a greater diameter than body portion 220, radial flange 222 is held within second mold assembly 200 by the now formed medicine container 100 when molding preform 198 has hardened around forming member 206. More specifically, radial flange 222 is in a fixed radial position relative to body portion 220 (i.e., radial flange 222 is not retractable relative to body portion 220) such that medicine container 100 facilitates holding radial flange 222 with a retaining force. Thus, in one embodiment, removing forming member 206 from second mold assembly 200 and from engagement with medicine container 100 includes forcibly pulling forming member 206 from medicine container 100 to overcome the retaining force. That is, medicine container 100 is fabricated from flexible and/or elastically deformable material which allows removal of forming member 206 from medicine container 100 without permanently deforming the shape of protrusion 122.

In one embodiment, radial flange 222 is retractable relative to body portion 220, and removing forming member 206 from medicine container 100 includes retracting radial flange 222 within body portion 220 before removing forming member 206 from medicine container 100. As such, radial flange 222 is retracted so as to not impede removal of forming member 206 from medicine container 100, thereby reducing the likelihood of potentially deforming protrusion 122 during the removal process.

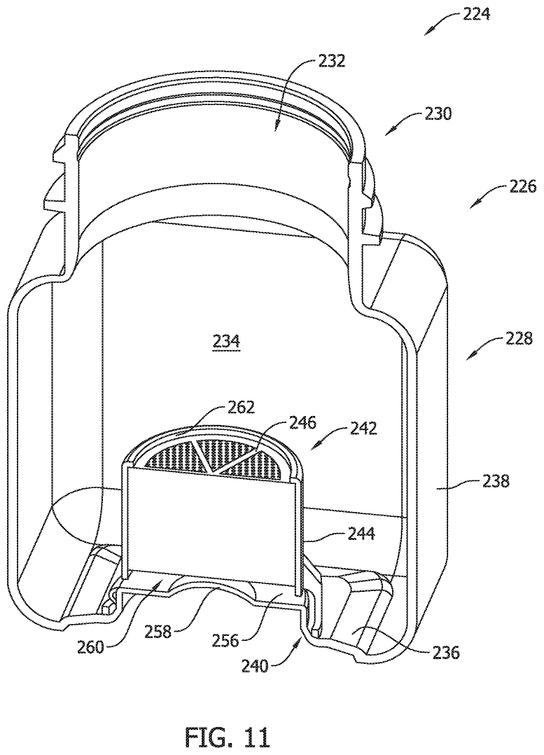

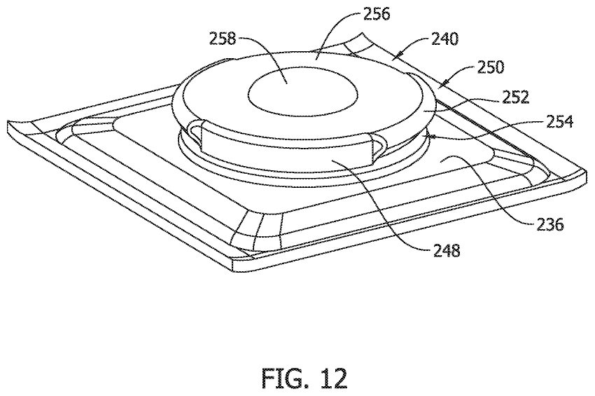

FIG. 11 is a cutaway perspective view of an additional medicine container 224, and FIG. 12 is a cutaway perspective view of a bottom portion of medicine container 224. In the example embodiment, medicine container 224 includes a container body 226 including a container portion 228 and a neck portion 230. Neck portion 230 defines an opening 232 that provides access to an interior 234 of container body 226. Container body 226 includes a bottom wall 236 and a side wall 238. Bottom wall 236 has a protrusion 240 formed thereon, and protrusion 240 is oriented to extend into interior 234. In addition, medicine container 224 includes a canister assembly 242 positioned within interior 234. Canister assembly 242 includes a canister base 244 and a desiccant canister 246 coupled to canister base 244, as will be explained in more detail below. Canister base 244 is removably coupled to protrusion 240. When coupled to protrusion 240, desiccant canister 246 is held in a fixed and stationary position within interior 234 of container body 226.

In the example embodiment, canister base 244 is coupled to protrusion 240 with a snap-fit connection. For example, as shown in FIG. 12, protrusion 240 includes a side wall 248 having at least one engagement feature 250 formed thereon. Engagement feature 250 includes a radial projection 252 that extends from side wall 248 such that a recess 254 is defined between radial projection 252 and bottom wall 236. Recess 254 is sized to receive a portion of canister base 244 therein to facilitate holding canister base 244 to protrusion 240 with the snap-fit connection. Protrusion 240 also includes a top surface 256 and an axial bump 258 formed on top surface 256.

Referring again to FIG. 11, axial bump 258 facilitates ensuring a gap 260 is formed between top surface 256 and desiccant canister 246 when canister base 244 is coupled to protrusion 240. More specifically, canister base 244 includes a retaining lip 262 formed thereon, which facilitates restricting axial movement of desiccant canister 246 within interior 234. However, desiccant canister 246 is otherwise movable relative to, and within, canister base 244. As such, desiccant canister 246 is positioned against axial bump 258 when canister assembly 242 is coupled to protrusion 240, and gap 260 is formed to facilitate providing airflow communication between interior 234 and desiccant canister 246.

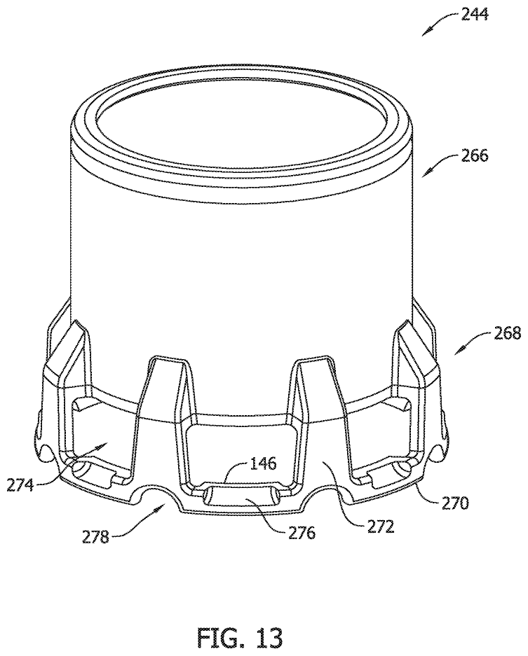

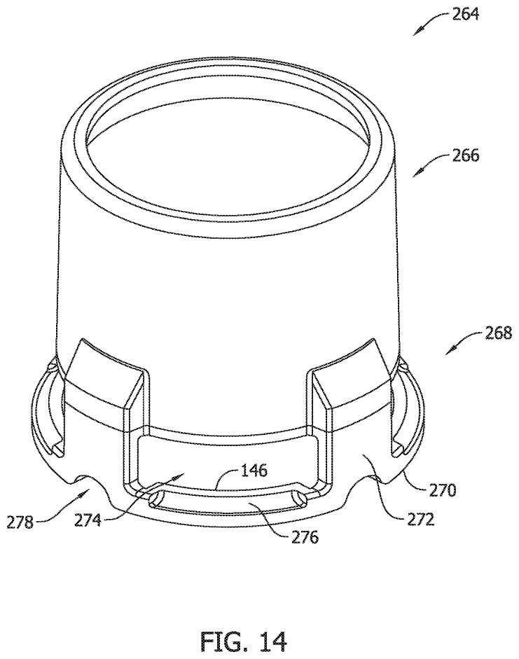

FIG. 13 is a perspective view of canister base 244, and FIG. 14 is a perspective view of an additional canister base 264. The description of canister base 244 is also applicable to canister base 264. In the example embodiment, canister base 244 includes a canister socket 266 and a base structure 268. Base structure 268 includes an annular ring 270 and a plurality of support members 272 extending between canister socket 266 and annular ring 270. The plurality of support members 272 are spaced circumferentially about annular ring 270 such that an air flow opening 274 is defined between adjacent support members 272. Annular ring 270 also has a plurality of indents 276 and a plurality of cutouts 278 formed therein, which enable annular ring 270 to achieve a balance of flexibility and rigidity to facilitate the snap-fit connection between canister base 244 and protrusion 240 (shown in FIG. 12).

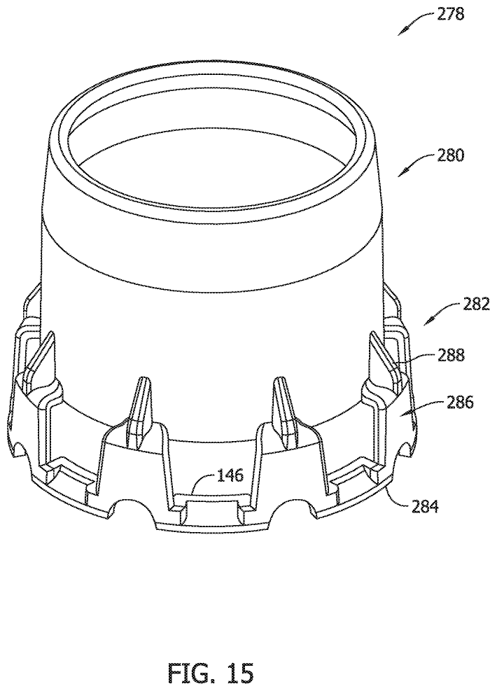

FIG. 15 is a perspective view of an additional canister base 278 that may be used with medicine container 224 (shown in FIG. 11). In the example embodiment, canister base 278 includes a canister socket 280 and a base structure 282. Base structure 282 includes an annular ring 284 and a plurality of support members 286 extending between canister socket 280 and annular ring 284. The plurality of support members 286 each include a support rib 288, which provides rigidity to canister base 278.

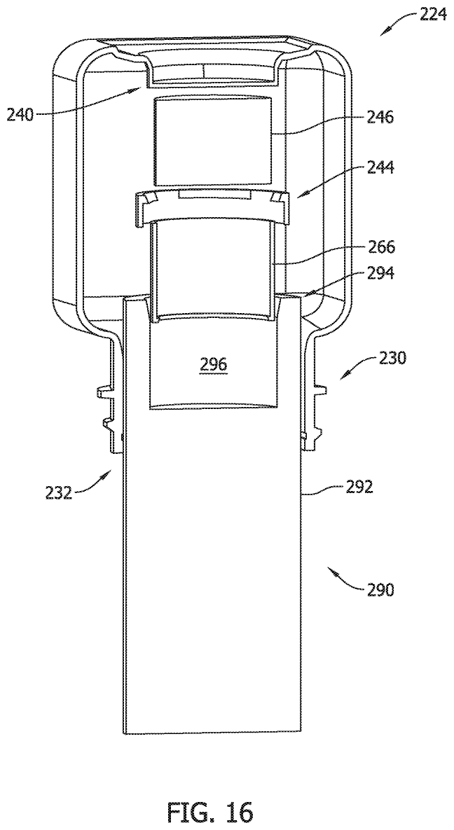

FIG. 16 is an exploded view of an example assembly apparatus 290 that may be used to assemble medicine container 224. In the example embodiment, assembly apparatus 290 includes a canister installation member 292 that is sized for insertion through opening 232 in neck portion 230. Canister installation member 292 includes a first end 294 and a canister cavity 296 defined at first end 294. Canister cavity 296 is sized to receive canister base 244 therein. For example, during an installation process, canister socket 266 of canister base 244 is positioned within canister cavity 296, and desiccant canister 246 is positioned within canister base 244. First end 294 of canister installation member 292 is then inserted through opening 232 and translated towards protrusion 240. Canister installation member 292 forces canister base 244 over protrusion 240 to enable the snap-fit connection to be formed therebetween. Thus, desiccant canister 246 is held against protrusion 240 by canister base 244 to facilitate restricting movement of desiccant canister 246 within medicine container 224. Canister installation member 292 is then retracted from within medicine container 224. In some embodiments, the installation process is performed while medicine container 224 is inverted, and canister base 244 is seated loosely within canister cavity 296. As such, the retaining force induced on canister base 244 by protrusion 240 as a result of the snap-fit connection is sufficient to facilitate removal of canister base 244 from canister cavity 296 during the installation.

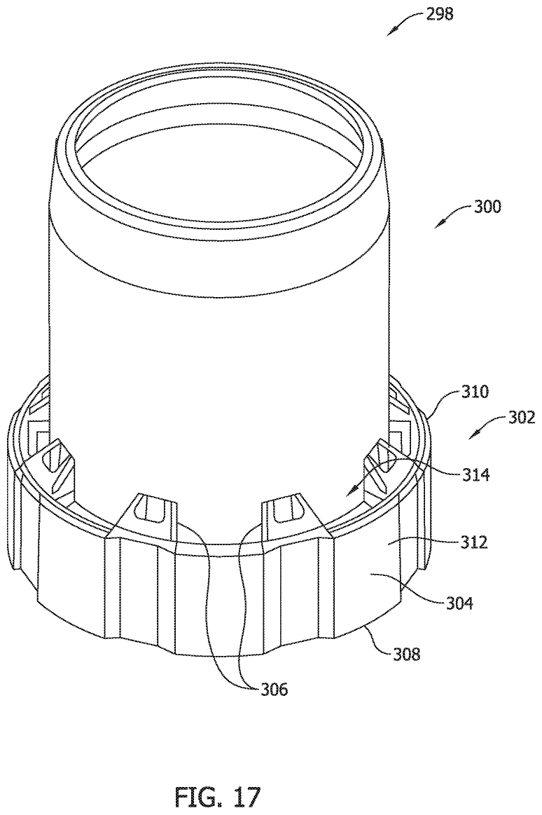

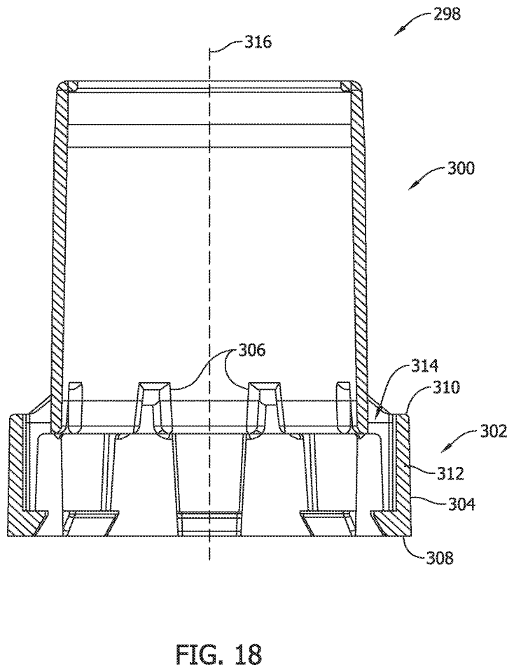

FIG. 17 is a perspective view of an additional canister base 298. In the example embodiment, canister base 298 includes a canister socket 300 and a base structure 302. Base structure 302 includes an annular ring 304 and a plurality of support members 306 extending between canister socket 300 and annular ring 304. Annular ring 304 has a bottom edge 308, a top edge 310, and body portion 312 extending therebetween. The plurality of support members 306 are spaced circumferentially about annular ring 304 such that an air flow opening 314 is defined between adjacent support members 306. Referring to FIG. 18, body portion 312 is substantially continuous between bottom edge 308 and top edge 310, and top edge 310 extends over canister socket 300 relative to a longitudinal axis 316 of canister base 298. As compared to canister base 244 (shown in FIG. 13), for example, body portion 312 is substantially free of slots or openings defined along the circumference of canister base 298. As such, the rigidity and gripping capability of canister base 298 is enhanced.

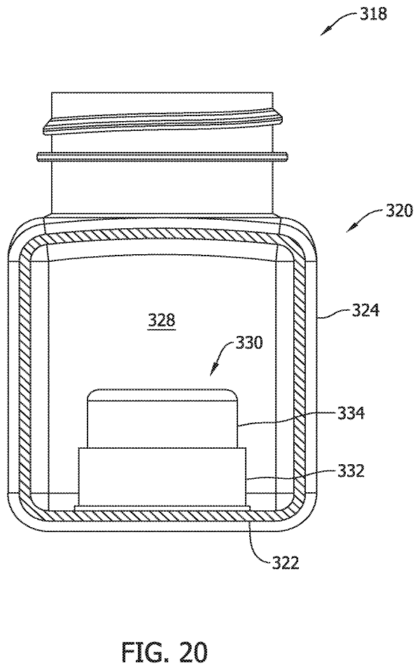

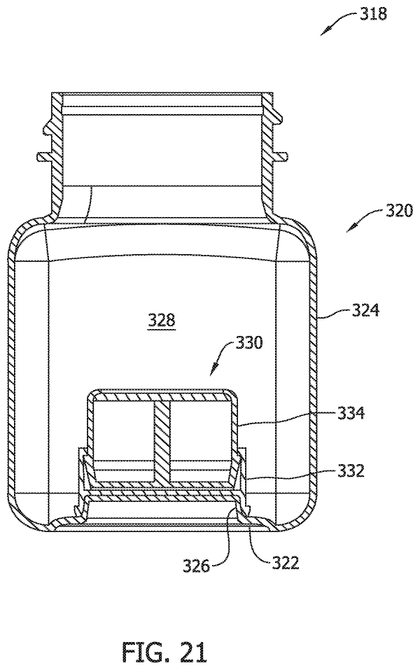

FIG. 20 is a front partial cutaway view of an additional medicine container 318, and FIG. 21 is a cross-sectional view of medicine container 318. In the example embodiment, medicine container 318 includes a container body 320 including a bottom wall 322 and a side wall 324. Bottom wall 322 has a protrusion 326 formed thereon, and protrusion 326 is oriented to extend into an interior 328 of medicine container 318. In addition, protrusion 326 has a substantially cylindrical shape free of projections, protuberances, discontinuities, and the like. Medicine container 318 also includes a canister assembly 330 positioned within interior 328. Canister assembly 330 includes a canister base 332 and a desiccant canister 334 coupled to canister base 332. Installing canister assembly 330 within medicine container 318 includes inserting canister assembly 330 within interior 328, and positioning canister base 332 over protrusion 326, such as with an interference fit, for example. Canister base 332 is then affixed to protrusion 326 using any suitable technique. For example, in one embodiment, canister base 332 is ultrasonically welded to protrusion 326. As such, canister base 332 is formed separately from, and then integrally joined with, protrusion 326 such that desiccant canister 334 is held in a fixed and stationary position within interior 328.

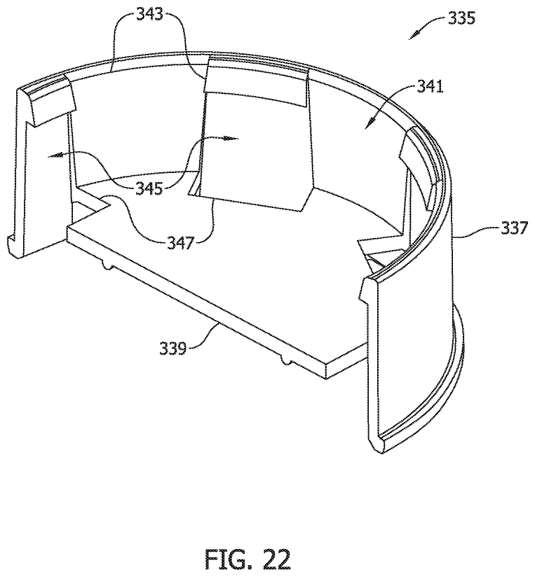

FIG. 22 is a perspective cross-sectional view of an additional canister base 335 that may be used in medicine container 318 (shown in FIG. 20). Canister base 335 includes a cylindrical side wall 337, a partition 339 coupled within an interior 341 defined by cylindrical side wall 337, and a plurality of retaining features 343 spaced circumferentially from each other about cylindrical side wall 337. Retaining features 343 extend from cylindrical side wall 337 towards interior 341. In addition, a plurality of indents 345 are defined in cylindrical side wall 337, and a plurality of cutouts 347 are defined in partition 339. Indents 345 and cutouts 347 enable retaining features 343 to be formed with a deeper undercut, as compared to canister base 332. As such, canister base 335 is capable of holding desiccant canister 334 (shown in FIG. 20) with an enhanced holding force.

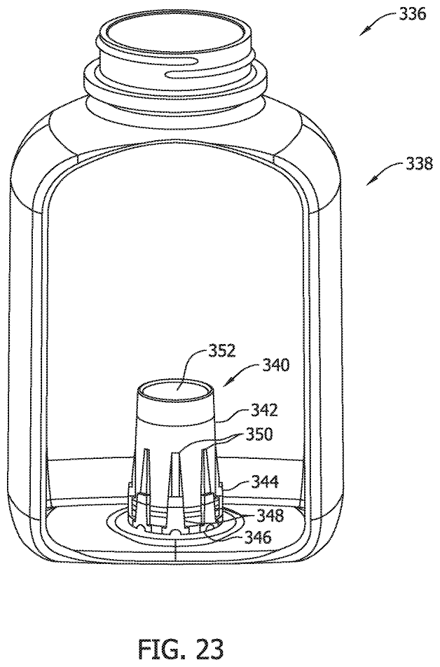

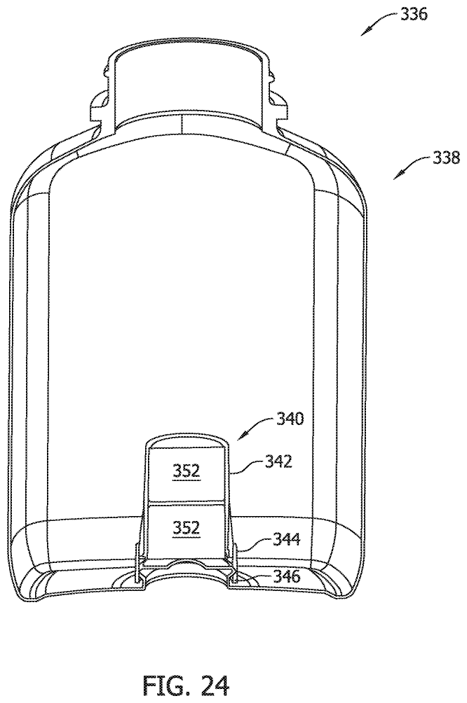

FIG. 23 is a partial cutaway view of an additional medicine container 336, and FIG. 24 is a cross-sectional view of medicine container 336. In general, medicine container 336 has a greater volumetric capacity than medicine container 100 (shown in FIG. 1), for example. Thus, medicine container 336 may be adapted to contain a greater amount of desiccant than medicine container 100. For example, medicine container 336 includes a container body 338 and an elongated canister base 340 coupled within container body 338. Elongated canister base 340 includes a canister socket 342 and a base structure 344. Base structure 344 includes an annular ring 346 and a plurality of support members 348 extending between canister socket 342 and annular ring 346. The plurality of support members 348 are spaced circumferentially about annular ring 346. In addition, support members 348 include a flow opening 350 defined therein.

Referring to FIG. 24, commercially available desiccant canisters 352 may only be available in limited sizes. As such, multiple desiccant canisters 352 are stackable to be aligned end-to-end within elongated canister base 340 to increase the amount of desiccant contained within medicine container 336. In addition, flow openings 350 have a length that enables both desiccant canisters 352 to be exposed to ambient air within medicine container 336. While shown as including two desiccant canisters 352, it should be understood that more than two desiccant canisters, or desiccant canisters of varying sizes, may be stacked within elongated canister base 340.

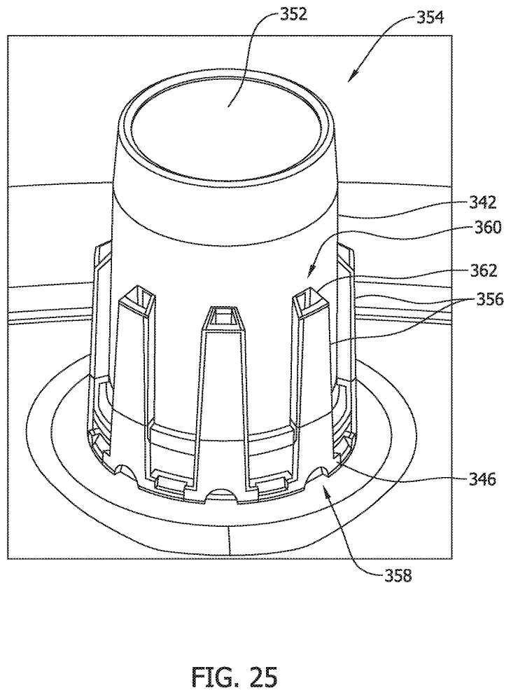

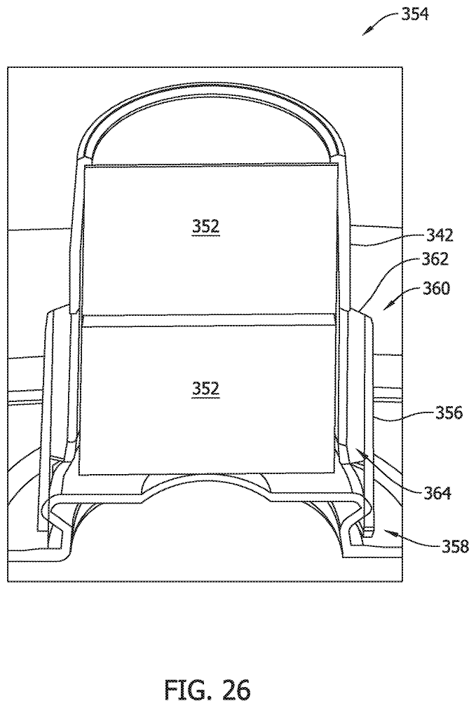

FIG. 25 is a perspective view of an additional elongated canister base 354 that may be used in medicine container 336, and FIG. 26 is a cross-sectional view of elongated canister base 354. Similar to elongated canister base 340 (shown in FIGS. 23 and 24), elongated canister base 354 also includes a plurality of support members 356 extending between canister socket 342 and annular ring 346, with the plurality of support members 356 spaced circumferentially about annular ring 346. Each support member 356 includes a base end 358 and a tip end 360, and a flow opening 362 defined at tip end 360. Referring to FIG. 26, a flow channel 364 is defined in canister socket 342, and support members 356 are oriented to enclose flow channel 364 such that flow opening 362 and flow channel 364 are in flow communication. As such, support members 356 have enhanced rigidity as compared to support members 348, support members 356 are configured to enable both desiccant canisters 352 to be exposed to ambient air within medicine container 336.

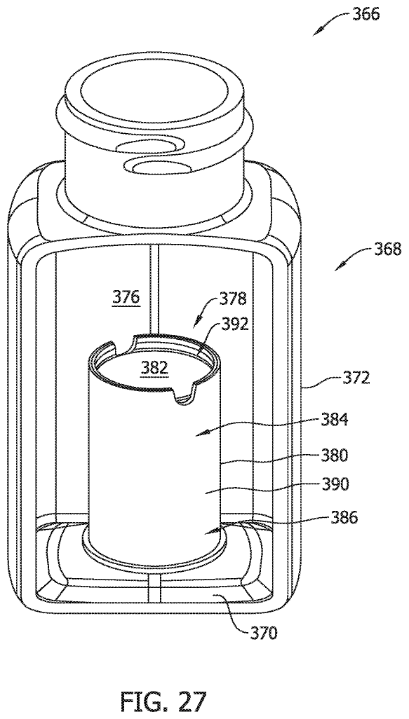

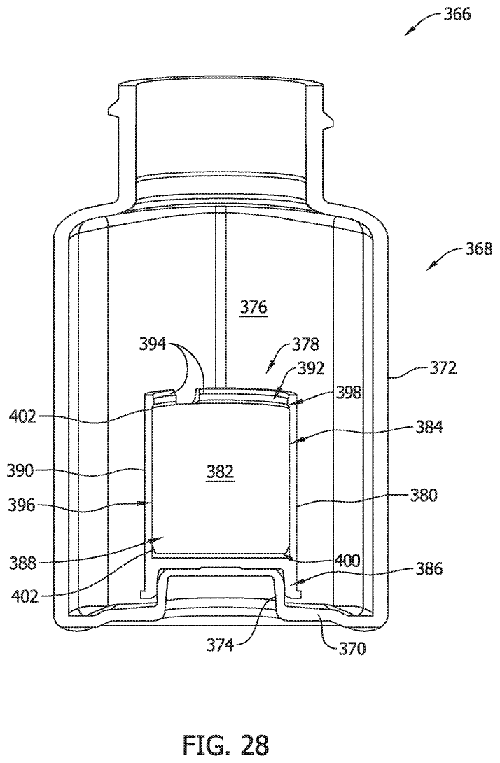

FIG. 27 is a partial cutaway view of an additional medicine container 366, and FIG. 28 is a cross-sectional view of medicine container 366. In the example embodiment, medicine container 366 includes a container body 368 including a bottom wall 370 and a side wall 372. Bottom wall 370 has a protrusion 374 formed thereon, and protrusion 374 is oriented to extend into an interior 376 of medicine container 366. In addition, protrusion 374 has a substantially cylindrical shape free of projections, protuberances, discontinuities, and the like. Medicine container 366 also includes a canister assembly 378 positioned within interior 376. Canister assembly 378 includes a canister base 380 and a desiccant canister 382 coupled to canister base 380. Installing canister assembly 378 within medicine container 366 includes inserting canister assembly 378 within interior 376, and positioning canister base 380 over protrusion 374, such as with an interference fit, for example. Canister base 380 is then affixed to protrusion 374 using any suitable technique. For example, in one embodiment, canister base 380 is ultrasonically welded to protrusion 374. As such, canister base 380 is formed separately from, and then integrally joined with, protrusion 374 such that desiccant canister 382 is held in a fixed and stationary position within interior 376.

Referring to FIG. 28, desiccant canister 382 is designed to facilitate coupling within canister base 380. For example, canister base 380 includes a canister socket 384 and a base structure 386. Canister socket 384 includes an interior 388, a side wall 390 at least partially defining interior 388, an opening 392 defined by side wall 390 and that provides access to interior 388, and a retaining feature 394 that extends from side wall 390 towards interior 388. In addition, desiccant canister 382 includes a substantially cylindrical body 396 having a first end 398 and a second end 400. Each of first end 398 and second end 400 are defined with a chamfer feature 402 that extends circumferentially about cylindrical body 396. Chamfer feature 402 is engageable with retaining feature 394 when desiccant canister 382 is inserted within interior 388 to facilitate holding desiccant canister 382 within interior 388. For example, chamfer feature 402 enables desiccant canister 382 to be engaged with canister socket 384 with a snap-fit connection.

This written description uses examples to disclose various implementations, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A medicine container comprising:
a container body comprising a bottom wall that at least partially defines an interior of the container body, wherein the bottom wall comprises a protrusion extending into the interior; and
a canister base coupled to the protrusion, wherein the canister base is configured to hold a desiccant canister within the interior of the container body when the canister base is coupled to the protrusion.

2. The medicine container in accordance with claim 1, wherein the canister base is coupleable to the protrusion with an interference fit.

3. The medicine container in accordance with claim 1, wherein the canister base is formed separately from, and then integrally joined with, the protrusion.

4. The medicine container in accordance with claim 1, wherein the protrusion has a substantially cylindrical shape free of projections, protuberances, discontinuities, and the like.

5. The medicine container in accordance with claim 1, wherein the canister base comprises a side wall that defines an opening in the canister base, a partition opposite the opening, and a canister socket formed on the partition, wherein the canister socket is configured to hold the desiccant canister.

6. The medicine container in accordance with claim 5, wherein the canister base is sized to extend over the protrusion such that the protrusion is insertable within the opening to couple the canister base to the protrusion.

7. The medicine container in accordance with claim 5, wherein at least one of the side wall and the partition of the canister base comprise at least one air flow opening defined therein such that an air flow path is provided between the interior of the container body and the desiccant canister through the canister base.

8. The medicine container in accordance with claim 5, wherein the canister socket comprises a plurality of retaining features configured to couple the desiccant canister to the canister base.

9. The medicine container in accordance with claim 8, wherein the plurality of retaining features are spaced circumferentially about the canister socket.

10. The medicine container in accordance with claim 8, wherein an ident defined in the side wall, and a cutout defined in the partition, are each associated with a respective retaining feature of the plurality of retaining features.

11. The medicine container in accordance with claim 5, wherein the canister base is coupleable to the protrusion with an interference fit to position the partition against the protrusion.

12. The medicine container in accordance with claim 1, wherein the container body further comprises a neck portion that defines an opening configured to provide access to the interior of the container body, and wherein the canister base is sized to be insertable through the opening.

13. A medicine container comprising:
a container body comprising a bottom wall that at least partially defines an interior of the container body, wherein the bottom wall comprises a protrusion extending into the interior; and
a canister base formed separately from, and then integrally joined with, the protrusion, wherein the canister base is configured to hold a desiccant canister within the interior of the container body when the canister base is coupled to the protrusion.

14. The medicine container in accordance with claim 13, wherein a weld joint is defined between the protrusion and the canister base.

15. The medicine container in accordance with claim 13, wherein the protrusion has a substantially cylindrical shape free of projections, protuberances, discontinuities, and the like.

16. The medicine container in accordance with claim 13, wherein the canister base comprises a side wall that defines an opening in the canister base, a partition opposite the opening, and a canister socket formed on the partition, wherein the canister socket is configured to hold the desiccant canister.

17. A method of assembling a medicine container, the method comprising:
inserting a canister base through an opening in the medicine container, wherein the medicine container includes a container body having a bottom wall and an interior at least partially defined by the bottom wall, wherein the bottom wall includes a protrusion extending into the interior;
coupling the canister base to the protrusion; and
coupling a desiccant canister to the canister base.

18. The method in accordance with claim 17, wherein coupling the canister base comprises coupling the canister base to the protrusion with an interference fit.

19. The method in accordance with claim 18 further comprising integrally joining the canister base to the protrusion with a weld.

20. The method in accordance with claim 17 further comprising induction sealing the opening such that the desiccant canister is sealed within the interior.
